(19) United States
(12) Patent Application Publication
(10) Pub. No.: US 2026/0070646 A1
(43) Pub. Date: Mar. 12, 2026

(54) MECHANICAL SUPPORT AND ATTACHMENT INTERFACE FOR A COMPOSITE LATTICE STRUCTURE, IN PARTICULAR ON A COMPOSITE STRUCTURE FORMING A FRAMEWORK OF A RIGID AIRSHIP

(71) Applicant: Flying Whales, Suresnes (FR)

(72) Inventors: Jessica Cohen, Paris (FR); Alain Deschamps, Dissay (FR); Maxime Dupressoir, Strasbourg (FR)

(21) Appl. No.: 19/108,876

(22) PCT Filed: Aug. 30, 2023
(86) PCT No.: PCT/EP2023/073759

§ 371 Date: Mar. 5, 2025

(30) Foreign Application Priority Data
Sep. 6, 2022 (FR) FR2208890

(51) Int. Cl. B64B 1/08; F16B 7/00

(52) U.S. Cl. CPC B64B 1/08; F16B 7/00

(57) ABSTRACT

A connection interface made of composite or possibly metal material for connecting at least one chord with at least two diagonals, wherein the sleeve has at least one sleeve provided to surround the chord about a longitudinal direction and at least two radially projecting sockets. Each of the sockets is designed to receive one end of one of the diagonals. The interface further includes a first reinforcing part extending between the two sockets, the reinforcing part having a bore forming an attachment point, and a second reinforcing part opposite the first reinforcing part with respect to the longitudinal direction, the second reinforcing part having a second bore forming an attachment point.

### CROSS-REFERENCE TO RELATED APPLICATIONS

This application is a national phase entry under 35 U.S.C. § 371 of International Patent Application PCT/EP2023/073759, filed Aug. 30, 2023, designating the United States of America and published as International Patent Publication WO 2024/052184 A1 on Mar. 14, 2024, which claims the benefit under Article 8 of the Patent Cooperation Treaty of French Patent Application Serial No. FR2208890, filed Sep. 6, 2022.

### TECHNICAL FIELD

The field of the present disclosure is that of devices for attaching systems to composite lattice girders, in particular, to a composite structure forming a framework of a rigid airship.

### BACKGROUND

In a non-limiting manner, the attached systems can be electrical harnesses, helium cells or even nets for the helium cells, and external panels.

The present disclosure relates to a connection interface made of composite material for connecting at least two bars, so as to form a lattice structure or a lattice element.

The term “lattice” is used herein to refer to an assembly of at least two chords linked together by connection nodes, also referred to by the term “connection interface,” so as to form one or more meshes between the bars.

In addition, the term “lattice element” refers to an elementary structure comprising two bars linked together by a connection node.

The composite lattice girders are composed of composite tubes assembled with connecting sleeves.

It is not recommended to attach systems directly to the composite tubes, as the properties of composite materials are optimized for tensile loads and not for shear loads (unlike metals, which are isotropic). Pultruded carbon tubes have the same thickness along their entire length, so that point loads requiring an increased local thickness of the tube will result in a thicker and heavier tube along the entire length of the bundle. The preferred location for an attachment point is therefore at the connection interfaces, as the additional load due to system integration will not require resizing of the girder.

International Application Publication No. WO 2019/079096 A1 describes systems, apparatus and methods for the rapid and cost-effective construction of an airship. In one embodiment, an airship structure may comprise a plurality of main frames, each comprising interconnected pyramid structures. One of the pyramid structures may comprise a top joint, four base joints, first connectors and second connectors. The top joint and the base joints can each comprise slots designed to receive connectors. The top joint can comprise four top-to-bottom slots, and each base joint can comprise one base-to-top slot and two base-to-base slots. Each of the first connectors can connect the top joint to one of the four base joints using one of the top-to-base slots of the top joint and the base-to-top slot of the base joint. Each of the second connectors can connect two of the four base joints using one of the base-to-base slots of each of the two base joints connected by this second connector.

The object of the present disclosure is to provide interfaces for connecting structures, such as lattices or lattice elements, which are light and strong, which are simple, inexpensive and repeatable.

### BRIEF SUMMARY

One aim of the present disclosure is notably to remedy all or part the aforementioned drawbacks. According to a first aspect of the present disclosure, a lattice structure is proposed, comprising at least one chord and at least two diagonals, and at least one connection interface intended to connect at least one chord in the form of a cylindrical tube to at least two diagonals, the connection interface comprising:
at least one sleeve intended to surround the chord about a longitudinal direction, the sleeve comprising:
at least two radially projecting sockets, each of the sockets being intended to receive one end of one of the diagonals,
a first reinforcing part extending between the two sockets, the first reinforcing point having a bore forming an attachment point,
a second reinforcing point opposite the first reinforcing part with respect to the longitudinal direction, the second reinforcing part further being provided with a second bore forming an attachment point,
an attachment having a half-cylinder extending along one direction, the internal diameter of the half-cylinder being equal to the external diameter of the sleeve of the interface,
the attachment further comprising two fins extending on either side of the ends of the half-cylinder in a plane transverse to the direction,
each of the fins having a flat surface coplanar with a flat surface of the other fin, forming a common bearing plane,
each of the fins having a bore, the distance between the bores being equal to the distance between the bores in the interface.

Each of the reinforcing parts has a receiving face intended to receive an accessory face.

Preferably, the receiving faces of the two reinforcing parts are coplanar.

The bores are used as an attachment point for the interfaces, but also to mechanically close the two half-cylinders around the chord, in addition to gluing, using fasteners (rivets, screws, etc.) which also serve to attach the interface.

The two bearing faces on the sleeve allow interface integration, independently or simultaneously.

The interface parts can be used to compensate for the alternating orientation of sleeves along a chord and to integrate equipment having a unique interface position (axis, for example).

According to a preferred configuration, the interface according to the present disclosure is formed by two half-shells intended to be assembled together, each having bearing faces arranged to bear against each other when the two half-shells are assembled.

Preferably, the second attachment point is arranged symmetrically to the first attachment point with respect to the longitudinal direction.

Advantageously, the axes of sockets and the longitudinal direction can be coplanar.

In particular, the axes of sockets can coincide with the longitudinal direction of the sleeve.

According to a third aspect of the present disclosure, an aircraft is proposed, preferably of the lighter-than-air aircraft type, even more preferably of the airship type, comprising a structure according to the second aspect of the present disclosure, or one or more of the improvements thereof, comprising subsystems attached to the structure via the connection interface.

According to another aspect of the present disclosure, a method is proposed for attaching equipment to a composite lattice structure having chords, comprising attaching attachment points of the equipment to the chord via a connection interface according to the first second aspect of the present disclosure, or one or more of the improvements thereof.

According to one embodiment, the method is implemented in an airship with a composite structure.

### BRIEF DESCRIPTION OF THE DRAWINGS

Other advantages and particularities of the present disclosure will become apparent on reading the detailed description of implementations and embodiments, which are in no way exhaustive, with reference to the appended drawings, in which:

FIG. 1 schematically depicts a perspective view of a part of a lattice structure according to one embodiment of the present disclosure;

FIG. 2 schematically depicts a perspective view of an interface according to one embodiment of the present disclosure;

FIG. 3 schematically depicts an exploded view of the view depicted in FIG. 2;

FIG. 4 schematically depicts a planar view of the interface depicted in FIG. 2;

FIG. 5 schematically depicts a view of the interface depicted in FIG. 2, according to plane BB schematized in FIG. 4;

FIG. 6 schematically depicts a first embodiment of an attachment engaging with the interface depicted in FIG. 2, referenced Type A;

FIG. 7 schematically depicts a second embodiment of an attachment engaging with the interface depicted in FIG. 2, referenced Type B;

FIG. 8 schematically depicts a third embodiment of an attachment engaging with the interface depicted in FIG. 2, referenced Type C;

FIG. 9 schematically depicts a fourth embodiment of an attachment engaging with the interface depicted in FIG. 2, referenced Type D;

FIG. 10 schematically depicts a fifth embodiment of an attachment engaging with the interface depicted in FIG. 2, referenced Type E; and

FIG. 11 schematically depicts a more complete perspective view of the lattice structure depicted in FIG. 1.

### DETAILED DESCRIPTION

Since the embodiments described below are in no way limiting, it will, in particular, be possible to consider variants of the present disclosure comprising only a selection of the features described, subsequently isolated from the other features described, if this selection of characteristics is sufficient to confer a technical advantage or to differentiate the present disclosure from the prior art. This selection comprises at least one feature, preferably functional, without structural details, or with only a portion of the structural details if this part only is sufficient to confer a technical advantage or to differentiate the present disclosure from the prior art.

In the figures, an element appearing in several figures retains the same reference.

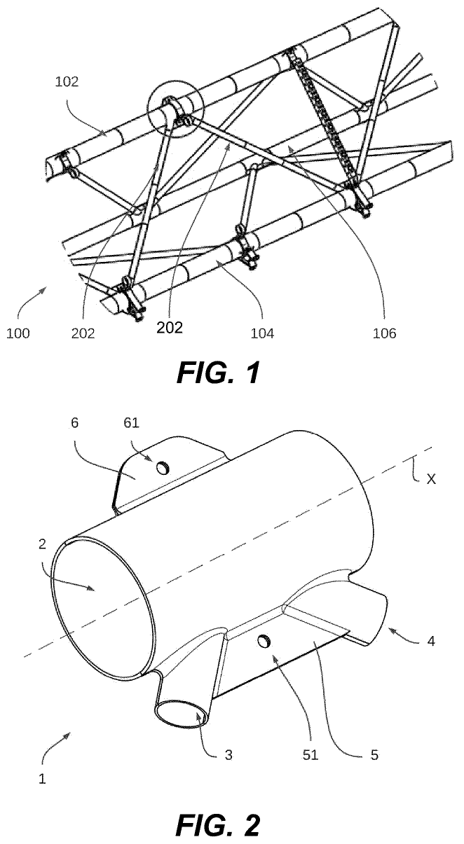

FIG. 1 shows a partial cutaway view of a lattice structure 100 comprising three chords 102, 104, 106, between which are arranged a number of diagonals 202. In the example shown, the chords and the diagonals are cylindrical tubes.

The chords and the diagonals form a lightweight structure. By lightweight structure, the present disclosure refers to a lattice-based structure. The chords and the diagonals are preferably made of composite material.

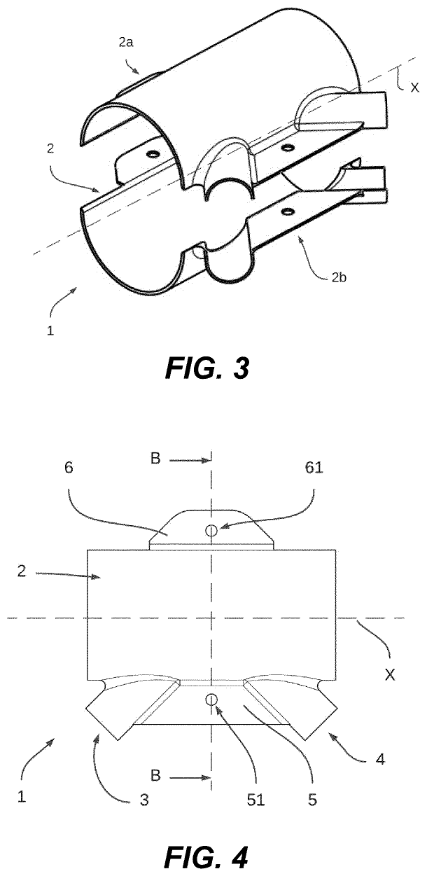

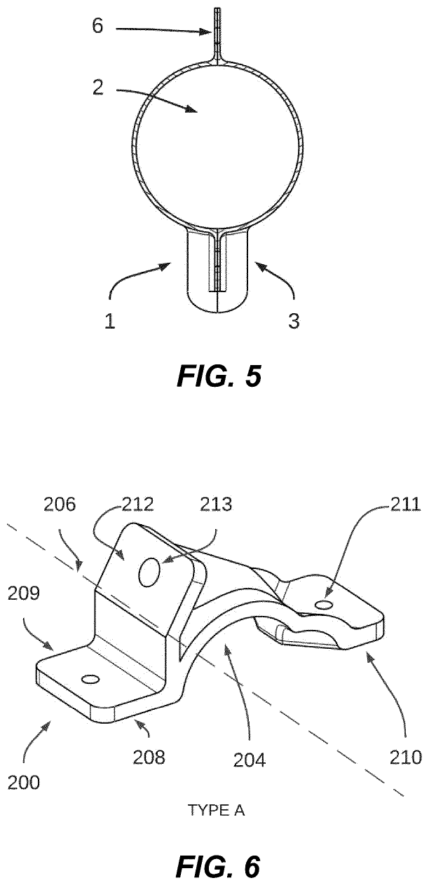

FIG. 2, FIG. 3, FIG. 4 and FIG. 5 show in more detail a connection interface 1 intended to connect the chord 102, and the two diagonals (also called web elements) 202.

The connection interface 1 is made of composite or plastic material, for example, a filled plastic. The material can be PA6 (nylon), PEEK or bioplastics. The connection interface can be made of composite or metal material, for example, aluminum.

The connection interface 1 has a sleeve 2 intended to surround the chord 102 about a longitudinal direction X of the chord.

The sleeve 2 is formed of half-shells 2a, 2b (FIG. 3) that are symmetrical with respect to a radial assembly plane in the longitudinal direction X.

According to one possibility that is shown, the two half-shells 2a, 2b each have bearing faces designed to be in contact when the two half-shells 2a, 2b are assembled.

The two half-shells can, for example, be glued together on their bearing face.

According to another possibility, the sleeve 2 could be formed of a single shell, which could be threaded onto the chord.

Assembly is easier with two half-shells.

The sleeve 2 is further provided with two radially projecting sockets 3, 4 (FIG. 2). Each of the sockets 3, 4 is intended to receive one end of one of the diagonals 202. In the example shown, each of the sockets forms a housing with a circular base adapted to a diagonal with a circular base.

In the example shown, the axes of sockets 3, 4 and the longitudinal direction are coplanar. Furthermore, in the example shown, the axes of sockets 3, 4 intersect the longitudinal direction of the sleeve 2 at an angle.

The sleeve 2 is further provided with a reinforcing part 5, which extends between the two sockets. In the example shown, the reinforcing part is substantially plate-shaped, extending radially with respect to the longitudinal direction X.

The first reinforcing part 5 has a bore 51 forming an attachment point. In the example shown, the bore 51 is substantially orthogonal to the thickness of the reinforcing part.

The sleeve 2 is further provided with a second reinforcing part 6. In the example shown, the reinforcing part 6 is substantially plate-shaped, extending radially with respect to the longitudinal direction X, on the opposite side to the first reinforcing part 5 with respect to the longitudinal direction X.

The second reinforcing part 6 is further provided with a second bore 61 forming an attachment point.

As can be seen from the figures, the two bores 51 and 61 are arranged symmetrically with respect to the longitudinal direction X.

The interface elements (surfaces and bores) are standardized (fixed center distance) for the entire range of values taken by the chord diameter. Thus, it is possible to integrate any type of equipment complying with this standard into each lattice node.

The definitions of interface parts allow their integration in the critical case where the diameter of the chord is at the maximum.

The two reinforcing parts are preferably identical in thickness and coplanar so that the fasteners can be installed in any desired orientation.

### Type A

Reference is now made to FIG. 6 for a first embodiment of a Type A fastener 200 arranged to engage with the connection interface 1 shown in FIG. 2.

The fastener 200 has a half-cylinder 204, preferably with an annular base, extending along a direction 206. The internal diameter of half-cylinder 204 is selected to be at least equal to the external diameter of the sleeve corresponding to the largest chord diameter. This is to allow a fastener to be used on sleeves of slightly different diameters and to limit the number of part numbers by associating them with a diameter range.

Fastener 200 further comprises two fins 208, 210 extending on either side of the ends of half-cylinder 204 in a plane transverse to direction 206. A fillet is formed between half-cylinder 204 and each of fins 208, 210.

Each of fins 208, 210 has a flat surface coplanar with a flat surface of the other fin, forming a common bearing plane. Thus, the common flat surface can be pressed against the plane defined by reinforcing parts 5 and 6 of interface 1.

Each of fins 208, 210 has a bore 209, 211. The distance between bores 209 and 211 is equal to that between bores 51 and 61 of interface 1. Thus, it is possible to lock fastener 200 to interface 1, for example, by way of a screw-nut system.

Fastener 200 further comprises a finger 212 extending from the intersection of half-cylinder 204 and fin 208, on the side of half-cylinder 204. Finger 212 has a threaded bore 213 intended for attaching a threaded insert thereto.

### Type B

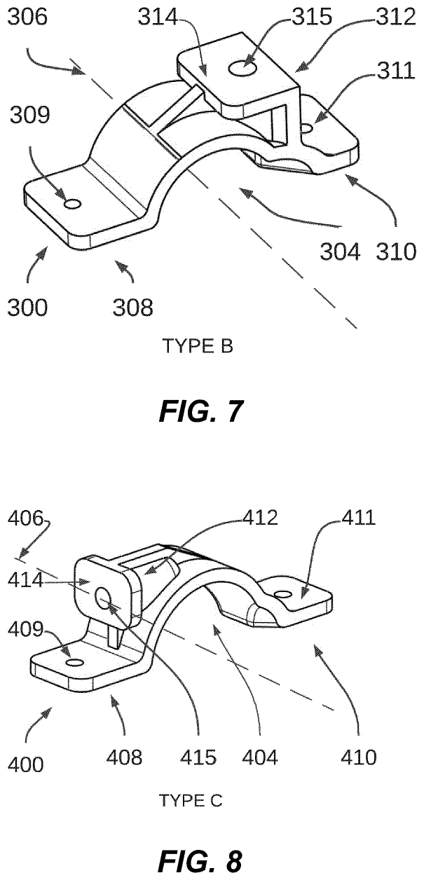

Reference is now made to FIG. 7 for a second embodiment of a Type B fastener 300 arranged to engage with the connection interface 1 shown in FIG. 2.

Fastener 300 has a half-cylinder 304, preferably with an annular base, extending along a direction 306. The internal diameter of half-cylinder 304 is selected to be at least equal to the external diameter of the sleeve corresponding to the largest chord diameter. This is to allow a fastener to be used on sleeves of slightly different diameters and to limit the number of part numbers by associating them with a diameter range.

Fastener 300 further comprises two fins 308, 310 extending on either side of the ends of half-cylinder 304 in a plane transverse to direction 306. A fillet is formed between half-cylinder 304 and each of fins 308, 310.

Each of fins 308, 310 has a flat surface coplanar with a flat surface of the other fin, forming a common bearing plane. Thus, the common flat surface can be pressed against the plane defined by reinforcing parts 5 and 6 of interface 1.

Each of fins 308, 310 has a bore 309, 311. The distance between bores 309 and 311 is equal to that between bores 51 and 61 of interface 1. Thus, it is possible to lock fastener 300 to interface 1, for example, by way of a screw-nut system.

Fastener 300 further comprises a finger 312 extending from the intersection of half-cylinder 304 and fin 308, on the side of half-cylinder 204. Finger 312 has a surface 314 parallel to the plane defined by the surfaces of fins 308, 310. Surface 314 is provided with a bore 315 intended for attaching an accessory thereto.

### Type C

Reference is now made to FIG. 8 for a third embodiment of a Type C fastener 400 arranged to engage with the connection interface 1 shown in FIG. 2.

Fastener 400 has a half-cylinder 404, preferably with an annular base, extending along a direction 406. The internal diameter of half-cylinder 404 is also selected to be at least equal to the external diameter of the sleeve corresponding to the largest chord diameter. This is to allow a fastener to be used on sleeves of slightly different diameters and to limit the number of part numbers by associating them with a diameter range.

Fastener 300 further comprises two fins 408, 410 extending on either side of the ends of half-cylinder 404 in a plane transverse to direction 406. A fillet is formed between half-cylinder 404 and each of fins 408, 410.

Each of fins 408, 410 has a flat surface coplanar with a flat surface of the other fin, forming a common bearing plane. Thus, the common flat surface can be pressed against the plane defined by reinforcing parts 5 and 6 of interface 1.

Each of fins 408, 310 has a bore 409, 411. The distance between bores 409 and 411 is equal to that between bores 51 and 61 of interface 1. Thus, it is possible to lock fastener 400 to interface 1, for example, by way of a screw-nut system.

Fastener 400 further comprises a finger 412 extending from the part of half-cylinder 404 furthest away from fins 408, 410. Finger 412 has a surface 414 perpendicular to the plane defined by the surfaces of fins 408, 410. Surface 414 is provided with a bore 415 intended for attaching an accessory thereto.

### Type D

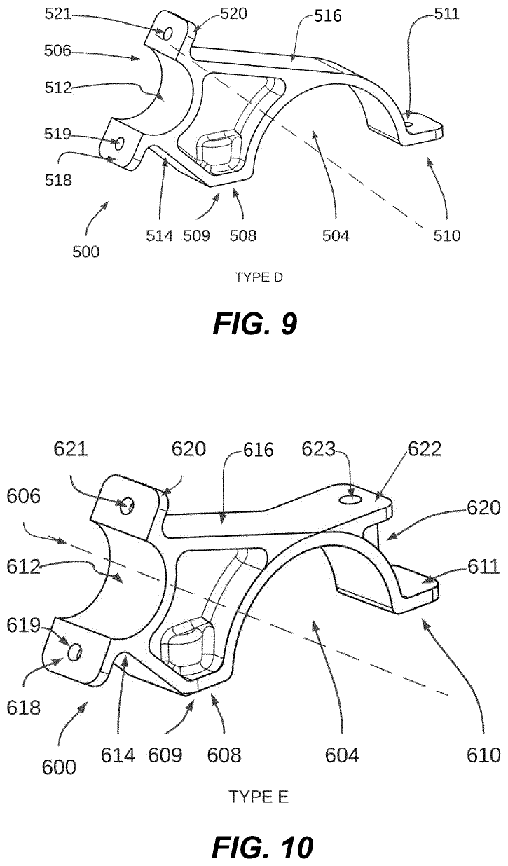

Reference is now made to FIG. 9 for a fourth embodiment of a Type D fastener 500 arranged to engage with the connection interface 1 shown in FIG. 2.

Fastener 500 has a half-cylinder 504, preferably with an annular base, extending along a direction 506. The internal diameter of half-cylinder 504 is selected to be at least equal to the external diameter of the sleeve corresponding to the largest chord diameter. This is to allow a fastener to be used on sleeves of slightly different diameters and to limit the number of part numbers by associating them with a diameter range.

Fastener 500 further comprises two fins 508, 510 extending on either side of the ends of half-cylinder 504 in a plane transverse to direction 506. A fillet is formed between half-cylinder 504 and each of fins 508, 510.

Each of fins 508, 510 has a flat surface coplanar with a flat surface of the other fin, forming a common bearing plane. Thus, the common flat surface can be pressed against the plane defined by reinforcing parts 5 and 6 of interface 1.

Each of fins 508, 510 has a bore 509, 511. The distance between bores 409 and 411 is equal to that between bores 51 and 61 of interface 1. Thus, it is possible to lock fastener 500 to interface 1, for example, by way of a screw-nut system.

Fastener 500 further comprises a half-cylinder 512 extending along an axis parallel to axis 506. The half-cylinder 512 is attached to fastener 500 by two struts 514, 516. Strut 514 transfers the forces exerted on half-cylinder 512 to the end of fin 508 opposite half-cylinder 504. Strut 516 transfers the forces exerted on half-cylinder 512 to the part of half-cylinder 504 furthest away from fins 508.

Fastener 500 further comprises two fins 518, 520 extending on either side of the ends of half-cylinder 512 in a plane transverse to direction 506. A fillet is formed between half-cylinder 512 and each of fins 518, 520.

Each of the fins 518, 520 has a flat surface coplanar with a flat surface of the other fin, forming a common bearing plane. Thus, the common flat surface defines a flat support suitable for receiving an accessory.

Each of fins 518, 520 has a bore 519, 521. Thus, it possible to lock an accessory, for example, by way of a screw-nut system.

### Type E

Reference is now made to FIG. 10 for a fifth embodiment of a Type E fastener 600 arranged to engage with the connection interface 1 shown in FIG. 2.

Fastener 600 has a half-cylinder 604, preferably with an annular base, extending along a direction 606. The internal diameter of half-cylinder 604 is selected to be at least equal to the external diameter of the sleeve corresponding to the largest chord diameter. This is to allow a fastener to be used on sleeves of slightly different diameters and to limit the number of part numbers by associating them with a diameter range.

Fastener 600 further comprises two fins 608, 610 extending on either side of the ends of half-cylinder 604 in a plane transverse to direction 606. A fillet is formed between half-cylinder 604 and each of fins 608, 610.

Each of fins 608, 610 has a flat surface coplanar with a flat surface of the other fin, forming a common bearing plane. Thus, the common flat surface can be pressed against the plane defined by reinforcing parts 5 and 6 of interface 1.

Each of fins 608, 610 has a bore 609, 611. The distance between bores 609 and 611 is equal to that between bores 51 and 61 of interface 1. Thus, it is possible to lock fastener 600 to interface 1, for example, by way of a screw-nut system.

Fastener 600 further comprises a half-cylinder 612 extending along an axis parallel to axis 606. The half-cylinder 612 is attached to fastener 600 by two struts 614, 616. Strut 614 transfers the forces exerted on half-cylinder 612 to the end of fin 608 opposite half-cylinder 604. Strut 616 transfers the forces exerted on half-cylinder 612 to the part of half-cylinder 604 furthest away from fins 608.

Fastener 600 further comprises two fins 618, 620 extending on either side of the ends of half-cylinder 612 in a plane transverse to direction 606. A fillet is formed between half-cylinder 612 and each of fins 618, 620.

Each of fins 618, 620 has a flat surface coplanar with a flat surface of the other fin, forming a common bearing plane. Thus, the common flat surface defines a flat support suitable for receiving an accessory.

Each of fins 618, 620 has a bore 619, 621. Thus, it possible to lock an accessory, for example, by way of a screw-nut system.

Fastener 600 further comprises a finger 620 extending from the intersection of half-cylinder 604 and fin 610, on the side of half-cylinder 604. Finger 620 has a surface 622 parallel to the plane defined by the surfaces of fins 608, 610. Surface 622 is provided with a bore 623 intended for attaching an accessory thereto.

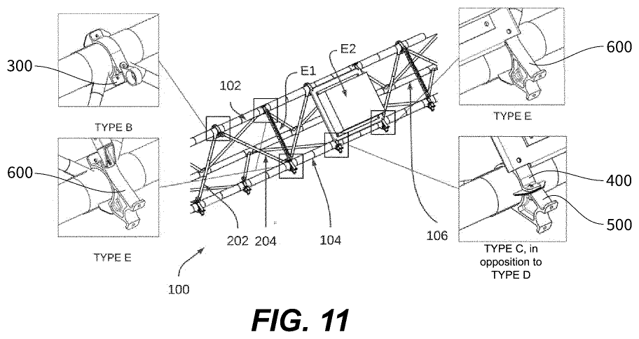

### FIG. 11

Referring to FIG. 11, a lattice structure 100 comprising a plurality of fasteners according to the present disclosure is now described.

More specifically, the detail of a type B interface is shown in the top left part, a detail of a type E interface is shown in the bottom left part, a detail of a type E interface, used to support an equipment plate, is shown in the top right part, and a detail of a type C interface, installed in opposition to a type D part, is shown in the bottom right part.

As shown in FIG. 11, it is thus possible to mount a ramp E1 in order to receive cables by way of two type B interfaces according to the present disclosure.

It is further possible to mount a panel E2 in order to receive other equipment (pump, data collector) (by way of four interfaces according to the present disclosure, including one type C) and one type E.

The structure thus makes it possible to attach subsystems in an airship featuring a structure conforming to the present disclosure.

Of course, the present disclosure is not limited to the examples that have just been described and numerous modifications can be made to these examples without departing from the scope of the present disclosure. In addition, the different features, forms, variants and embodiments of the present disclosure may be associated with one another in various combinations insofar as they are not incompatible or exclusive of one another.

1. A lattice structure, comprising:
at least one chord in the form of a cylindrical tube;
at least two diagonals; and
at least one connection interface configured to connect the at least one chord to the at least two diagonals, the connection interface including at least one sleeve configured to surround the at least one chord about a longitudinal direction, the at least one sleeve comprising:
at least two radially projecting sockets, each of the at least two radially projecting sockets configured to receive one end of one of the diagonals;
a first reinforcing part extending between the two sockets, the first reinforcing part having a bore forming first attachment point; and
a second reinforcing part opposite the first reinforcing part with respect to the longitudinal direction, the second reinforcing part having a second bore forming a second attachment point; and
a fastener having a half-cylinder extending along a direction. an internal diameter of the half-cylinder being equal to an external diameter of the sleeve of the at least one connection interface, the fastener having two fins extending on either side of the ends of the half-cylinder in a plane transverse to the direction, each of the two fins having a flat surface coplanar with a flat surface of the other fin, forming the same common bearing plane, each of the two fins having a bore, a distance between the bores of the two fins being equal to a distance between the bores of the at least one connection interface.

2. The lattice structure of claim 1, wherein the at least one connection interface includes two half-shells intended to be assembled together, each having bearing faces arranged to bear against one another when the two half-shells are assembled.

3. The lattice structure of claim 2, wherein the second attachment point of the at least one connection interface is arranged symmetrically to the first attachment point of the at least one connection interface with respect to the longitudinal direction.

4. The lattice structure of claim 3, wherein axes of the at least two radially projecting sockets and the longitudinal direction of the at least one connection interface are coplanar.

5. The lattice structure of claim 4, wherein the axes of the at least two radially projecting sockets intersect the longitudinal direction of the sleeve.

6. An aircraft, comprising:
a lattice structure according to claim 1; and
at least one subsystem attached to the lattice structure by the at least one connection interface.

7. A method for attaching a piece of equipment including a chord to a composite lattice structure, comprising:
providing a composite lattice structure including:
at least one chord in the form of a cylindrical tube;
at least two diagonals; and
at least one connection interface configured to connect the at least one chord to the at least two diagonals, the connection interface including at least one sleeve configured to surround the at least one chord about a longitudinal direction, the at least one sleeve comprising:
at least two radially projecting sockets, each of the at least two radially projecting sockets configured to receive one end of one of the diagonals;
a first reinforcing part extending between the two sockets, the first reinforcing part having a bore forming a first attachment point; and
a second reinforcing part opposite the first reinforcing part with respect to the longitudinal direction, the second reinforcing part having a second bore forming a second attachment point; and
a fastener having a half-cylinder extending along a direction, an internal diameter of the half-cylinder being equal to an external diameter of the sleeve of the at least one connection interface, the fastener having two fins extending on either side of the ends of the half-cylinder in a plane transverse to the direction, each of the two fins having a flat surface coplanar with a flat surface of the other fin, forming the same common bearing plane, each of the two fins having a bore, a distance between the bores of the two fins being equal to a distance between the bores of the at least one connection interface; and
attaching the piece of equipment to the fastener.

8. The method according to claim 7, wherein the piece of equipment and the composite lattice structure are components of an airship.

9. The lattice structure of claim 1, wherein the second attachment point of the at least one connection interface is arranged symmetrically to the first attachment point of the at least one connection interface with respect to the longitudinal direction.

10. The lattice structure of claim 1, wherein axes of the at least two radially projecting sockets and the longitudinal direction of the at least one connection interface are coplanar.

11. The lattice structure of claim 1, wherein the axes of the at least two radially projecting sockets intersect the longitudinal direction of the sleeve.
